(19) United States
(12) Patent Application Publication
(10) Pub. No.: US 2017/0320355 A1
(43) Pub. Date: Nov. 9, 2017

(54) GROOVE PROTECTOR SLEEVE

(71) Applicants: Danny Coker, Leesburg, GA (US); Shana Coker, Leesburg, GA (US)

(72) Inventors: Danny Coker, Leesburg, GA (US); Shana Coker, Leesburg, GA (US)

(21) Appl. No.: 15/147,163

(22) Filed: May 5, 2016

(51) Int. Cl. B44D 3/12

(52) U.S. Cl. CPC B44D 3/128

(57) ABSTRACT

A groove protection device that includes: a cylindrical wall, where the cylindrical wall is adapted for placement around a container; a countersunk top cap at the top of the cylindrical wall; a containment wall around the top cap; and an opening in the top cap, where the opening enables access to liquid product within the container. The groove protection device may also include a seal under the top cap to assist in groove protection. The seal extends downward into the container and the seal includes a notch to facilitate the placement of the seal into the container. A handle opening may be provided along the cylindrical wall, where the handle opening enables placement of the cylindrical wall over the handle.

### BACKGROUND OF THE INVENTION

### Field of Invention

The present invention relates to groove protection device that is used in conjunction with a quart or gallon paint type containers, which consist of liquid products of paint, varnish, stain, adhesive, glue or the like.

### Description of Related Art

Many trade professionals (carpenters, workers in industry, painters, etc.) and Do-It-Yourselfers use liquid products directly out of a can while administering the product with a brush applicator. The liquid product is typically sealed within a tin or plastic can which includes a removable tin lid. This lid is sealed when it properly seats into the groove on top of the can. During the use of the product in the can, the open groove becomes contaminated with liquids that become dried. As result, a user cannot properly seal the can. Air seepage begins to cure the product inside the can. Trying to clear the groove manually becomes cumbersome, and the can prematurely has to be disposed. The ability to tightly seal the lid back into a clean groove can be very important to prevent air from curing the product and preserve any unused product within the can for later use. As a result, it would be advantageous to have a device that could be used in conjunction with a container of the prior art that protects the open, delicate groove of the can.

### SUMMARY OF THE INVENTION

The present invention relates to a groove protection device that includes: a cylindrical wall, where the cylindrical wall is adapted for placement around a container; a countersunk top cap at the top of the cylindrical wall; a containment wall around the top cap; and an opening in the top cap, where the opening enables access to a liquid product within the container. The seal extends downward and presses outward against the opening of the container due to characteristics of the composition of the seal. The seal includes a notch to facilitate the placement of the seal into the opening of the can. A handle opening is provided for paint type containers along the cylindrical wall, where the handle opening enables placement of the cylindrical wall over the handle.

### BRIEF DESCRIPTION OF DRAWINGS

FIG. 1 depicts a first embodiment of a groove protector sleeve in accordance with the present invention. This depicts the quart container sleeve.

FIG. 2 depicts a top view of the groove protector sleeve top cap according to present invention. This illustration represents quart and gallon top cap assemblies.

FIG. 3 depicts the bottom view of the top cap and shows placement of seal. This illustration represents quart and gallon top cap assemblies.

FIG. 4 depicts an alternative groove protector sleeve, according to the present invention. This depicts the gallon container sleeve.

FIG. 5 depicts a sectional view of the top cap and seal. This illustration is used on both quart and gallon protector sleeves.

FIG. 6 depicts an exploded view of a corner of the seal and notch according to the present invention.

### DETAILED DESCRIPTION

The present invention relates to a groove protector sleeve that is placed over the outer surface and top groove area of an existing container. The container's normally come in two popular sizes, a quart and a gallon size. They also come in tin and plastic composition. The groove protector sleeve will accommodate all types. The quart size can is cylindrical with an open top and has no handle. As stated, the lid of a can may be removed and an open groove is exposed. In order to protect this open groove, the present invention allows the placement of the groove protector sleeve over the open groove and provides a protective top surface for the can during use. The top cap of the groove protector sleeve according to present invention includes an opening that allows a user access to the product within the can. This opening does not limit usage of appropriate brush applicators. The quart groove protector sleeve will accommodate up to 2 inch brushes and the gallon groove protector sleeve will accommodate up to 4 inch brushes. Further features of the groove protector sleeve include a countersunk top cap that has a containment wall that extends above the top cap. A containment wall is provided around the top cap that helps to further contain the product within the can and around the perimeter of the opening. A seal extends beneath the top cap. Its purpose is to provide the tight grip of the groove protector sleeve, to provide draining product from flowing into the groove underneath and to provide an “anti-slosh” feature to prevent liquid product from splashing into groove from underneath protector. The seal is cylindrical and includes a notch around the perimeter to allow the assertion into an existing can opening. The seal also enables it to accommodate tin and the larger width plastic can.

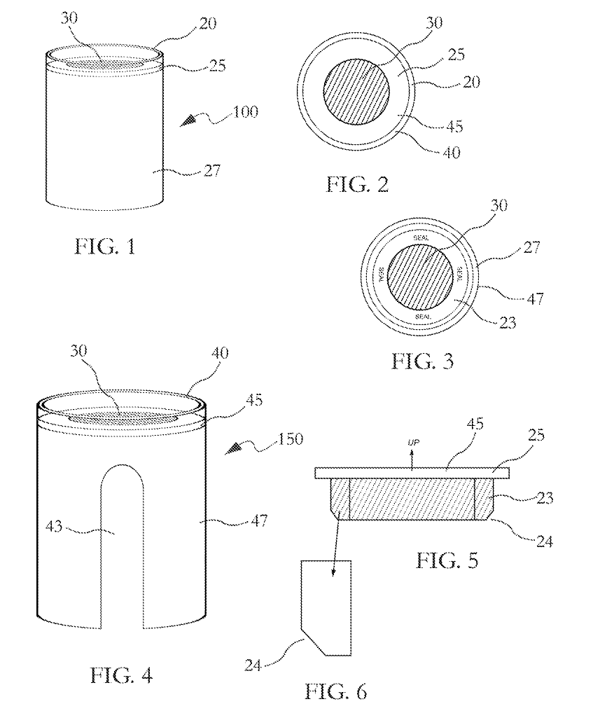

In reference to FIG. 1, a groove protector sleeve 100 in accordance to its present invention is depicted. Preferably, this particular embodiment of the present invention is used in conjunction with a quart size can and includes a cylindrical wall with a top cap positioned at the top of the cylindrical wall. The cylindrical wall covers the outer perimeter of the can and the top cap includes an opening to allow access to the liquid product within a can. During use, the user removes the existing lid of a can and slides the groove protector sleeve 100 over the can. A cylindrical wall 27 is shown with countersunk top cap 25. The top cap 25 includes a containment wall 20 that extends vertically above the top cap 25. Opening 30 is provided for access to the container. FIGS. 2 and 3 depict illustrations that are commonly used in FIG. 1 (Quart) and FIG. 4 (Gallon). FIG. 2 shows a top view of the top cap 25/45 of the groove protector sleeve 100 and 150, the protruding edge of the containment wall 20/40 and the top cap opening 30. FIG. 3 is the bottom view of the top cap of the groove protector sleeve 100 and 150. The seal 23 is shown, which makes it possible for the groove protector sleeve to fit tin and plastic containers. The opening 30 is maintained for access to liquid product within the can.

FIG. 4 depicts an alternative embodiment of the groove protector sleeve as shown in groove protector sleeve 150. This sleeve is used on gallon containers. The groove protector sleeve 150 also includes the opening 30 at the top cap 45. A containment wall 40 extends above the top cap 45 for containment of liquid product, where the top cap is on the top portion of cylindrical side wall 47. The cylindrical side wall 47 includes a slot opening 43 that allows for the placement of the protector sleeve 150 over a gallon paint type container. The slot opening 43 is adapted for the insertion of the handle that's normally associated with a gallon paint type container.

A sectional view of the top cap 25/45 is shown in FIG. 5, which shows seal 23 extending down with a notch 24 provided. The notch 24 is more closely shown in the exploded view of FIG. 6. This notch 24 allows for insertion of the seal 23 directly into the interior of the can opening and therefore locking the groove protector sleeve, by use of grip pressure, into place over the can during use. The groove protector sleeve therefore allows the user to continue to use the traditional container, but avoid excessive spillage of liquid product during use and further protects the groove opening to allow for proper sealing of the can after use. This protective sleeve preserves the remaining liquid product for later use. This invention has been shown and described in what it considers to be the most practical and preferred embodiments. It is recognized, however, that departures may be made there from within the scope of the invention and that obvious modifications may occur to a person skilled in the art.

What is claimed is:

1. A groove protection device comprising:
a. a cylindrical wall, where the cylindrical wall is adapted for placement around a container;
b. a countersunk top cap at the top of the cylindrical wall;
c. a containment wall around the top cap; and
d. an opening in the top cap, where the opening enables access to liquid product within the container.

2. The groove protection device according to claim 1, further a seal under the top cap to assist in groove protection.

3. The groove protection device according to claim 1, further including a handle opening along the cylindrical wall, where the handle opening enables placement of the cylindrical wall over the handle.

4. The groove protection device according to claim 2, where the seal extends downward into the container and the seal includes a notch to facilitate the placement of the seal into the container.
